(19) United States
(12) Patent Application Publication
(10) Pub. No.: US 2015/0203285 A1
(43) Pub. Date: Jul. 23, 2015

(54) CAPSULE FOR THE PREPARATION OF BEVERAGES, DEVICE AND METHOD

(71) Applicant: KJONINKLIJKE PHILIPS N.V., EINDHOVEN (NL)

(72) Inventor: Massimo Baldo, Eindhoven (NL)

(21) Appl. No.: 14/421,589

(22) PCT Filed: Aug. 26, 2013
(86) PCT No.: PCT/IB2013/056880

§ 371 Date: Feb. 13, 2015

Related U.S. Application Data
(60) Provisional application No. 61/696,842, filed on Sep. 5, 2012.

(51) Int. Cl. B65D 85/804; A47J 31/40

(52) U.S. Cl. CPC B65D 85/8043; A47J 31/407

(57) ABSTRACT

A capsule (1) for preparing a beverage is disclosed. The capsule comprises: an ingredient receptacle (3), which contains at least one ingredient (I) for the preparation of a beverage, and a sealed liquid container (7) containing an amount of liquid sufficient for preparing a beverage by means of said at least one ingredient (I). A liquid-tight separating wall (3B) is arranged between the liquid container (7) and the ingredient receptacle (3). The separating wall (3B) is arranged to be ruptured to cause the liquid to contact the at least one ingredient and produce a beverage.

### FIELD OF THE INVENTION

The present disclosure relates to the preparation of beverages using single serving capsules containing one or more ingredients for the preparation of a beverage by infusion with a liquid, e.g. hot water.

### BACKGROUND OF THE INVENTION

The use of pre-packaged ingredients for the preparation of hot beverages, in particular coffee, tea or the like, is becoming more and more popular. Capsules containing ground coffee powder, soluble ingredients, in some instances condensed milk and the like, tea leaves and other ingredients are known.

Capsules are sometimes sealed and are perforated once introduced in a brewing chamber to flow hot and possibly pressurized water through the ingredients contained in the capsule. In other known capsules one or both the water inlet and the beverage outlet walls of the capsule are water pervious, so that the need for a perforating or piercing arrangement on one or both sides is dispensed with.

Irrespective of the structure of the capsule and of the ingredients contained therein, the devices commonly used for the preparation of beverages by means of such capsules are comprised of a water tank, a pump and a water heater. The pump delivers the fresh water from the water tank through the water heater at the requested pressure. The water is heated in the water heater, which is usually a flow-through water heater, or so-called instant water heater, and is finally caused to flow through the capsule in order to extract the ingredients and prepare the beverage.

These machines are rather complicated and expensive, due to the relatively large number of components arranged therein. The presence of a water tank, a pump and a water heater, which usually comprises in turn a water duct and a resistor, make the machine cumbersome.

The quality of the final beverage strongly depends upon the quality of the water available to fill the water tank.

Moreover, the machines of this kind are relatively energy consuming, since the water contained in the water heater must be maintained at high temperature so that the machine is ready for brewing a beverage upon request. Even though flow-through water heaters contain a relatively small amount of water, they still absorb a certain amount of electric power to keep the water steadily at the required temperature, unless they are placed in the stand-by mode.

Water heaters and other components of the hydraulic circuit of the machine require from time to time a descaling cycle, to remove lime scale from the hydraulic circuit.

### SUMMARY OF THE INVENTION

The present invention provides a novel kind of capsule which partly or entirely overcomes at least one of the abovementioned drawbacks of the prior art.

According to a further aspect the invention also relates to a machine and to a system for the preparation of beverages using capsules, which partly or entirely overcomes the abovementioned problems of the prior art machines, as well as a novel method of preparing beverages using pre-packed capsules.

According to the invention, the capsule is a self-contained capsule, containing the ingredients for the preparation of the beverage, including the liquid, preferably water, required for extracting, dissolving, diluting or suspending one or more beverage ingredients, thus producing the beverage. An external source of water can therefore be dispensed with.

When the capsule is intended for the preparation of a hot beverage, the use of a self-contained capsule allows the beverage to be prepared without the need for an external water source and without a water heater through which the water flows.

According to one aspect, therefore, the invention provides a capsule for preparing a beverage, comprising: an ingredient receptacle, which contains at least one ingredient for the preparation of a beverage, and a sealed liquid container containing an amount of liquid sufficient for the complete amount of said at least one ingredient to prepare a beverage. The liquid-tight separating wall is arranged between the liquid container and the ingredient receptacle, and is arranged to be ruptured to cause said liquid to contact said at least one ingredient and produce said beverage.

Contrary to known capsules including two or more separate volumes, for separately preserving beverage ingredients, which are designed for mixing the ingredients and extracting the beverage by means of a flow of liquid, e.g. hot water, dispensed through the capsule, the capsule according to the invention contains the amount of liquid sufficient for the preparation of a dose of beverage, such that no additional water or any other liquid is required.

The capsule can contain one or more ingredient receptacles. For instance, two such receptacles can be provided, e.g. if two ingredients are required for the preparation of the beverage and said ingredients must be preserved one separated from the other. In some embodiments instant coffee powder can be contained in a first ingredient receptacle and condensed milk in a second ingredient receptacle, for the production of a milk and coffee beverage. Water can be contained in a separate water container and brought into contact with the coffee powder and the condensed milk upon preparation of the beverage.

In preferred embodiments the one or more ingredients are intended for the preparation of a hot beverage. In such case the liquid, e.g. water, can be heated before being brought in contact with the ingredient(s).

The action of bringing the liquid in contact with the ingredient(s) can be for the purpose of extracting flavors from the ingredients, e.g. coffee powder, tea leafs or the like. In other embodiments the action of bringing the liquid in contact with the ingredient(s) can be for the purpose of dissolving and/or diluting one or more ingredients in the liquid, and/or for forming a suspension of ingredient(s) in the liquid, with or without a preliminary liquid-heating step.

For example, the ingredient(s) can comprise concentrated flavors, to be diluted in water, or instant coffee to be dissolved in water or the like.

In some embodiments the liquid container and said ingredient receptacle are arranged and configured so that upon rupturing the separating wall the liquid flows through the ingredient receptacle, e.g. by reducing the volume of the liquid container. A liquid flow can be established e.g. by squeezing or collapsing the liquid container. The beverage produced is dispensed from the capsule, e.g. through a capsule wall arranged on one side of the ingredient receptacle opposite the separating wall. The ingredient receptacle can be liquid pervious, in which case the beverage is dispensed without requiring any perforation, aperturing or piercing action on the capsule. In other embodiments, the outer walls of the ingredient receptacle can be liquid-tight and preferably gas-tight and in such case aperturing by e.g. piercing, perforating, bursting or cutting of the outer wall of the ingredient receptacle is required. The latter embodiment avoids the need for an outer package preserving the integrity of the ingredients contained in the capsule and can thus be preferred in some circumstances.

For instance, the capsule can be divided in two capsule volumes, arranged one on top of the other, with the separating wall arranged therebetween. The liquid is contained in one of the two volumes and the at least one ingredient is contained in the other of the two volumes. Each volume is thus bounded by the separating wall and by a portion of the outer walls of the capsule. In other embodiments, the ingredient receptacle can be entirely contained in the liquid container and be surrounded by the latter or vice-versa.

In advantageous embodiments, the liquid container is at least partly delimited by an at least partly collapsible wall. For instance, the liquid container can have a collapsible or squeezable side wall. In some embodiments, the liquid container can be bounded by two opposing end walls, e.g. a top wall and a bottom wall and by a side wall extending between the two opposing end walls. The side wall can be collapsible or squeezable, so that the two opposing end walls can be moved one towards the other, thus reducing the inner volume of the liquid container and forcing the liquid to flow out of the liquid container. One of the end walls can be the top wall or the bottom wall of the capsule. The capsule can be generally cylindrical, conical, frustum-conical, pyramidal or frustum-pyramidal, prismatic, or the like. In preferred embodiments the capsule has a circular cross section, a top wall and a bottom wall. The other of the end walls of the water container can be the separating wall arranged between the liquid container and the ingredient receptacle.

In preferred embodiments the ingredient receptacle is gas tight for improved preservation of the ingredient(s). Gas tight receptacles can be provided by using a gas-tight foil, membrane, film or lamina forming the receptacle. For example the capsule can be manufactured using an aluminum foil, or a plastic film or membrane or a combination thereof. Gas and liquid tight capsules are thus obtained, which can be perforated on one side, for example, for dispensing the beverage. Perforation can be by way of one or more needles, cutters, piercers, or the like, or by means of the inner pressure built up during beverage preparation. In some instances the outer wall of the capsule can be provided with a rupturing line, e.g. an area of reduced thickness of the foil or film forming the capsule, to facilitate rupturing of the capsule and dispensing of the beverage.

In other embodiments, the capsule can be provided with a gas and liquid pervious wall in the area of the ingredient receptacle. The use of a piercer or perforator can in this case be dispensed with. The capsule can be wrapped in an outer gas-tight package to preserve the beverage ingredients. In other embodiments a peelable foil or film can be attached to seal the gas and liquid pervious wall portion. The peelable foil or film can be removed before using the capsule.

According to some embodiments the capsule can comprise a piercing arrangement for piercing the separating wall. The piercing arrangement can comprise one or more tips, blades, knobs, protrusions, projections or other members which cause rupture of the separating wall between the liquid container and the ingredient receptacle. In other embodiments the piercing arrangement can be comprised of pre-rupturing lines, areas, or portions provided in one or more locations along the separating wall. These rupturing lines, areas or portions can be ruptured by increasing the liquid pressure in the liquid container. This can be obtained e.g. by providing areas where the separating wall has a reduced thickness.

In some embodiments the piercing arrangement comprises a piercer arranged inside the liquid container and oriented towards the separating wall, said piercer being arranged for approaching and perforating said separating wall by collapsing said liquid container.

According to a further aspect, the invention provides a beverage producing device comprising: a capsule-receiving chamber configured for receiving a capsule comprised of a liquid container and an ingredient receptacle separated by a liquid-tight separating wall arranged therebetween. The capsule-receiving chamber comprises means for squeezing or collapsing the liquid container of a capsule positioned in the capsule-receiving chamber, causing the liquid to contact at least one beverage ingredient contained in the ingredient receptacle and prepare a beverage therewith.

The capsule-containing chamber can be a brewing chamber.

In some embodiments one or more piercers can be provided to pierce the capsule and allow the beverage to be dispensed from the capsule. In other embodiments, the piercer can be dispensed with and the capsule can be provided with a pre-rupturing line, area or location or the capsule can have a liquid-pervious wall portion for dispensing the beverage.

In preferred embodiments the device further comprises a heat generator configured and arranged for heating the liquid contained in the capsule when the capsule is arranged in the capsule-receiving chamber. In some embodiments, the heater can comprise a micro-wave generator.

The means for squeezing the liquid container of a capsule positioned in the capsule-receiving chamber can comprise two opposite end walls, movable one towards the other.

According to yet a further aspect, a system for producing a beverage is provided, using a capsule. The system comprises: a capsule-receiving chamber; a capsule receivable in the capsule-receiving chamber, the capsule being comprised of a liquid container and an ingredient receptacle separated by a liquid-tight separating wall arranged therebetween. The capsule-receiving chamber comprises means for squeezing or collapsing the liquid container of said capsule positioned in the capsule-receiving chamber, causing said liquid to contact at least one beverage ingredient contained in said ingredient receptacle and prepare a beverage therewith.

The capsule can be configured as described above and the capsule-receiving chamber can be combined with a heat generator configured and arranged for heating the liquid contained in the capsule arranged in the capsule-receiving chamber.

Further features and advantages of the invention are set forth in the following description of exemplary embodiments thereof and in the enclosed claims, which form an integral part of the present description.

### BRIEF DESCRIPTION OF THE DRAWINGS

A more complete appreciation of the invention and many of the advantages thereof will be readily obtained as the same becomes better understood by reference to the following detailed description when considered in connection with the accompanying drawings, which show one exemplary non-limiting embodiment of the invention. In the drawings:

FIG. 1 illustrates a section along a plane containing the axis of a capsule according to the invention, in one schematic embodiment;

FIG. 2 illustrates a perspective view of the capsule of FIG. 1;

FIGS. 3A-3D illustrate the main components of a machine according to the invention using a capsule according to FIG. 1 in four steps of a brewing cycle;

FIG. 4 illustrates a section according of a brewing chamber and the main components of a machine for preparing beverages with a capsule according to FIGS. 1 and 2, along a plane containing the axis of the brewing chamber;

FIGS. 5 and 6 schematically illustrate sections of two further embodiments of a capsule according to the invention arranged in a brewing chamber of a machine for the preparation of a beverage;

FIG. 7 illustrates a section of a further embodiment of a capsule according to the invention; and

FIG. 8 illustrates a cross-section according to line VIII-VIII of FIG. 7.

### DETAILED DESCRIPTION OF EMBODIMENTS

The following detailed description of exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

The following detailed description of some embodiments of the invention are directed to a capsule configured for the production of a hot beverage, e.g. coffee, using hot brewing water flowing from a water container through a receptacle containing the beverage ingredients. In other embodiments, the capsule can be configured for producing a cold beverage, e.g. by flowing cold water or another liquid through an ingredient receptacle, which contains the beverage-preparing ingredients.

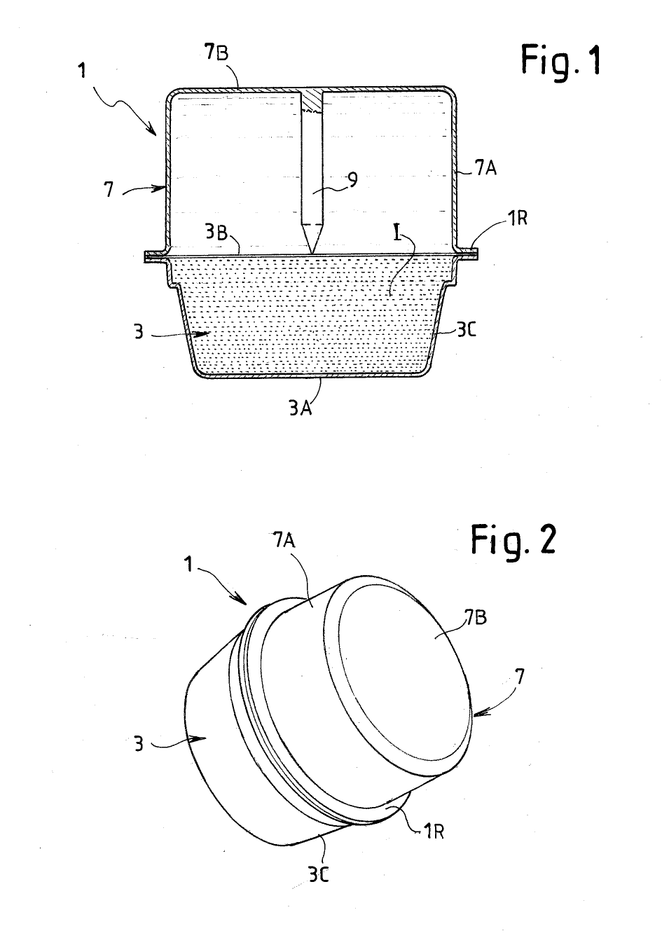

In FIGS. 1 and 2 a first embodiment of a capsule according to the present disclosure is schematically illustrated, FIG. 2 being a perspective view and FIG. 1 being a section along a plane containing the axis of symmetry of the capsule. The capsule is labeled 1 and comprises a receptacle 3 containing one or more ingredients for the preparation of a beverage. Here below the receptacle 3 will be designated “ingredient receptacle”. In some embodiments, the ingredient receptacle 3 can contain a dose of ground coffee powder.

In the example illustrated in FIGS. 1 and 2 the ingredient receptacle 3 forms the lower part of the capsule 1 and can have any suitable shape. In the exemplary embodiment illustrated in the drawings, the lower part of the capsule 1 forming the ingredient receptacle 3 is generally frustum shaped and has a bottom, beverage-outlet wall or surface 3A and an opposite top, water-inlet wall 3B. Between the water-inlet wall 3B and the beverage-outlet wall 3A a side wall 3C is provided. The ingredient receptacle 3 can also have a shape different than frustum-conical. For example the ingredient receptacle 3 can be frustum-shaped, e.g. frustum-conical, frustum-pyramidal or the like, or else it can be prismatic.

In some embodiments the walls 3A, 3B and 3C are impervious to gas, e.g. air, i.e. they sealingly close the inner volume of the ingredient receptacle 3, so that the ingredient contained therein is preserved, for example against oxidation, as well as against degradation due to air moisture and the like.

The outer walls 3C and 3A of the ingredient receptacle 3 can be made of PET or other plastic material suitable for packaging edible products. The water-inlet wall 3B is preferably made of a thinner film or web, of the same or different material with respect to the outer walls. The water-inlet wall 3B can be welded around the peripheral edge to the side wall 3C.

The upper part of the capsule 1 is formed by a liquid container 7. In the exemplary embodiments disclosed herein, water is used as a liquid for the preparation of the beverage. In other embodiments, not shown, a different liquid can be contained in the liquid container 7, such as milk.

The water container 7 preferably contains a quantity of water suitable for the preparation of one or more cups of an edible product, in particular a beverage, by means of the ingredients contained in the ingredient receptacle 3.

In the exemplary embodiment shown in FIGS. 1 and 2 the liquid container 7 is substantially cylindrical, but other shapes are possible. For example the liquid container 7 can be frustum-shaped, e.g. frustum-conical, frustum-pyramidal or the like, or else it can be prismatic.

The inner volume of the liquid container 7 is water tightly closed by a side wall 7A, a top wall 7B and the top, water-inlet wall 3B of the ingredient receptacle 3. The water-inlet wall 3B therefore forms a water-impermeable separating wall, which separates the water contained in the water container 7 from the ingredients contained in the ingredient receptacle 3.

The liquid container 7 can be formed by PET or other suitable material, which can be identical, similar or equivalent to that forming the ingredient receptacle 3. The liquid container 7 can be welded along the edge thereof to the separating wall 3B, which can in turn be welded to the edge of the side wall 3C of the ingredient receptacle 3, as mentioned above.

In some embodiments the liquid container 7 comprises a piercer 9. In the exemplary embodiment illustrated in FIGS. 1 and 2 the piercer 9 comprises a needle extending from the inner surface of the top wall 7B of the liquid container 7 downwardly towards the separating wall 3B. As will be described later on, other forms of perforator arrangements can be provided. In other embodiments, not shown, more than one needle can be provided to generate more than one aperture in the separating wall 3B.

The side wall 7A of the liquid container 7 is collapsible, i.e. it can be squeezed thus pushing the piercer 9 against the separating wall 3B causing rupture or piercing thereof. As will be explained later on, hot water is forced from the liquid container 7 through the apertures formed in the separating wall 3B and through the ingredients contained in the ingredient receptacle 3 to produce an edible, liquid product.

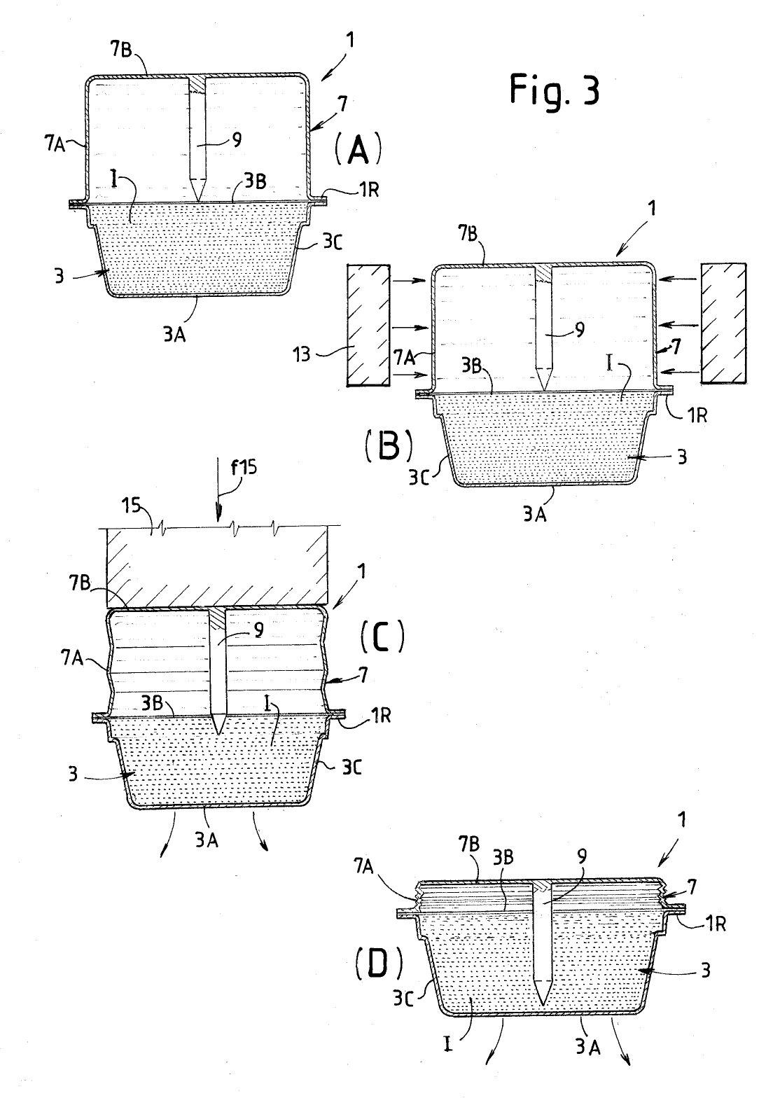

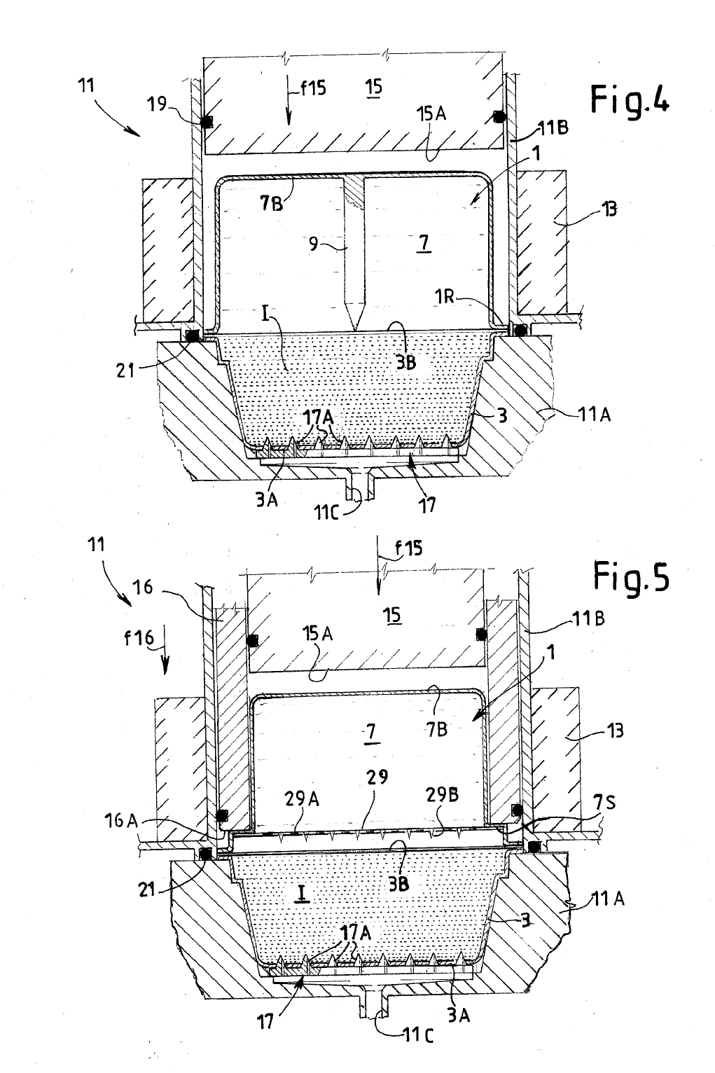

The manner of using the capsule of FIGS. 1 and 2 is schematically represented in the sequence of FIG. 3. FIG. 4 schematically illustrates a capsule-receiving chamber with a capsule introduced therein at the beginning of a beverage preparation cycle.

FIG. 3A shows the capsule 1 prior to being squeezed and collapsed by squeezing means arranged in a capsule-receiving chamber configured as schematically shown in FIG. 4. The capsule-receiving chamber is indicated here below as a brewing chamber and is globally labeled 11 in FIG. 4. The brewing chamber can comprise a first brewing chamber portion 11A and a second brewing chamber portion 11B (FIG. 4), which can be opened for receiving a capsule 1 therein and closed for performing a brewing cycle.

The brewing chamber 11 is combined with a heater, which is capable of heating the water contained in the liquid container 7 of the capsule 1. In some embodiments, as disclosed in FIGS. 3 and 4, the heater comprises a microwave generator, e.g. a magnetron, similar to those used in microwaves ovens.

As will be disclosed in greater detail in connection with FIGS. 4, 5 and 6, the brewing chamber can further comprise a perforator which perforates the bottom wall 3A of the capsule, to provide one or more apertures through which the beverage can flow out of the capsule towards a beverage dispensing nozzle or the like. Moreover, the brewing chamber comprises a capsule-squeezing arrangement, to squeeze the water container 7. In the exemplary embodiments shown in the drawings, the capsule-squeezing arrangement comprises a piston 15 which defines a movable wall 15A, arranged for squeezing the capsule 1 once the water contained in the water container 7 has been heated at the required temperature.

In an alternative embodiment (not shown) the means for squeezing or collapsing the liquid container 7 of a capsule are arranged to seal off the capsule-receiving chamber when a capsule is contained therein and subsequently increase the pressure within the capsule-receiving chamber.

In FIG. 3B the heating step is represented. The heater 13 heats the water contained in the liquid container 7 of capsule 1. As mentioned above the heater 13 can be or can comprise a microwave generator, e.g. a magnetron. Once the temperature required for brewing has been achieved, for example around 85° C., dispensing of the water through the ingredients can start (FIG. 3C). The temperature of the water can be controlled by a suitable sensor, if required, not shown. The temperature can be selected by the user. In general, the temperature depends upon the kind of ingredients contained in the capsule.

To dispense the water from the liquid container 7 through the ingredients contained in the ingredient receptacle 3, the piston 15 is pushed towards the ingredient receptacle 3, so that squeezing of the liquid container 7 starts by collapsing the outer side wall 7A of the water container 7. Advantageously, the inner volume of the liquid container 7 is not entirely filled with water, but rather contains a part of a gaseous media, for example nitrogen or air. This allows the volume of the liquid container 7 to be reduced by squeezing the capsule and compressing the gas contained therein, to an extent sufficient to cause perforation of the separating wall 3B by means of the piercer 9.

Once the separating wall 3B has been apertured, water flows from the liquid container 7 through the ingredients contained in the ingredient receptacle 3 and produces the beverage, which flows out of the capsule 1 through the aperture(s) generated by the perforator provided in the brewing chamber in a position opposite the piston 15. FIG. 3D shows the final stage of the brewing cycle, with the liquid container 7 entirely collapsed.

Using the capsule 1 a beverage can thus be produced with a very simple machine, requiring only a brewing chamber and a heater, for example a microwave heater, which is not subject to accumulation of lime scale, since no water flows therethrough. This device is much more compact than a common beverage producing machine, such has a manual or automatic coffee preparing machine.

FIG. 4 illustrates an exemplary embodiment of the capsule-receiving chamber or brewing chamber of the beverage producing machine in more detail.

In this embodiment the two brewing chamber portions 11A and 11B are arranged one on top of the other, but it should be understood that the position of the brewing chamber can be different, for example horizontal. The two brewing chamber portions 11A and 11B are movable one with respect to the other to open the brewing chamber and introduce the capsule 1 therein. In FIG. 4 the brewing chamber 11 is shown in the closed position with the capsule 1 placed therein, before the squeezing the capsule.

The brewing chamber portion 11A comprises a beverage dispensing nozzle 11C at the bottom. In the brewing chamber portion 11A a perforator plate 17 is arranged. In this embodiment the perforator plate 17 comprises a plurality of preferably sharp projections 17A designed to perforate the bottom wall 3A of the ingredient receptacle 3. In some embodiments the projections 17A can be liquid pervious so that the beverage can flow therethrough. In other embodiments the projections 17A can be solid, and holes or liquid passages can be provided in the perforator plate 17 around the projections 17A.

The shape of the perforator can be different from the one shown by way of example in the drawings. For instance, a single perforator can be provided, located in a suitable position, for example approximately in the center of the beverage outlet wall of the brewing chamber portion 11A. In other embodiments, a perforator could be dispensed with, e.g. if the capsule is provided with rupturing lines on the wall 3A. For example, one or more lines of reduced thickness can be provided in the wall 3A, said lines defining weakening areas, where the wall 3A will break or burst when the pressure in the ingredient receptacle 3 overcomes the breakage limit of the material forming the weakening areas of the wall 3A.

Between the ingredients, generically shown at I in the drawings, and the wall 3A a filter (not shown) can be arranged, so that solid ingredients, e.g. coffee powder, will not escape the ingredient receptacle.

In other embodiments, not shown, the bottom wall 3A can be water pervious, for example it can be formed by a web of tissue paper, nonwovens or the like, or else it can be formed by an apertured plastic wall, combined with a filter paper, a filtering non-woven or the like. Preservation of the ingredients contained in the ingredient receptacle 3 can be obtained by means of a peelable sealing foil which is removed by the user prior to introducing the capsule in the brewing chamber. In other embodiments, the capsule can be preserved e.g. against oxidation by an external gas-tight envelope.

In the example illustrated in FIG. 4 the magnetron 13 is supported or embedded in the upper brewing chamber portion 11B. It shall be understood that other arrangements are possible, for example the magnetron 13, or any other heating means, could be arranged in a fixed position inside the machine surrounding the brewing chamber portions 11A and/or 11B.

An electric resistor can be used instead of a microwave generator for heating the water contained in the capsule 1. However, microwaves are at present preferred, because more efficient heating is achieved.

Suitable shields, not shown can be provided for shielding the electromagnetic waves generated by the magnetron 13. Shielding arrangements are well known in the art of microwaves ovens, for example.

In the embodiment illustrate in FIG. 4, a movable piston 15 with a capsule-squeezing wall 15A is slidingly arranged in the brewing chamber portion 11B and can be moved according to arrow f15 downwards against the capsule 1, i.e. towards the perforator 17 arranged in the chamber portion 11A, in order to squeeze the capsule 1, once the brewing chamber has been closed. The piston 15 can be driven by any actuator suitable for this purpose, for example an electric actuator, a hydraulic actuator, for example a cylinder-piston system, or any other suitable mover.

Preferably, a sealing ring or the like, such as a lip gasket or an O-ring 19, can be provided between the inner surface of the brewing chamber portion 11B and the piston 15 slidingly arranged therein, preventing the beverage from flowing upwards, for example if a counter-pressure valve is provided downstream of the perforator 17. Counter-pressure valves are usually provided in coffee makers, for example to generate a cream forming the top cream layer typical of espresso coffee.

In other embodiments, as again schematically shown in FIG. 4, the capsule 1 can be provided with a rim 1R at the area where the ingredient receptacle 3 is welded to the water container 7. The rim 1R can be sealingly engaged between the two brewing chamber portion 11A and 11B. A gasket 21 can be provided on one or the other, or both, the brewing chamber portions 11A and 11B.

FIG. 5 illustrates a second embodiment of a capsule 1 according to the present invention placed in the brewing chamber of a beverage preparing machine. The same reference numbers designate the same or corresponding portions of the capsule 1 as well as of the coffee producing machine, as in the previously described example. Those components which are common to the previously described embodiment will not be described again.

The main difference between the embodiment of FIGS. 1 to 4 and the embodiment of FIG. 5 concerns the shape of the piercing member provided in the water container 7. In the embodiment of FIG. 5, a piercing plate, labeled 29, is provided instead of a needle 9. The piercing plate 29 is provided with through apertures 29A and sharp projections 29B facing towards the separating wall 3B which separates the liquid container 7 from the ingredient receptacle 3.

In this embodiment, the shape of the side wall 7A of the liquid container 7 is such as to form an annular shoulder 7S approximately surrounding the piercing plate 29. The piercing plate 29 can be attached to the inner surface of the side wall of the liquid container 7 along the shoulder 7S. The shoulder 7S serves the purpose which will became clearer from the following description of the operation of the capsule-receiving chamber or brewing chamber schematically illustrated in FIG. 5.

The capsule-receiving chamber 11 or brewing chamber of FIG. 5 differs from the brewing chamber of FIG. 4 in that in the brewing chamber portion 11B a double piston is arranged. A first piston 15 provided with a lower surface 15A is slidingly arranged inside a second piston 16 having an annular cross-section and an annular bottom surface 16A. The dimensions of the two pistons 15 and 16 is such that the piston 15 acts upon the top surface or top wall 7B of the liquid container 7, while the annularly shaped piston 16 acts upon the shoulder 7S. Arrows f15 and f16 represent the movement of the two pistons 15 and 16 respectively.

Once the capsule 1 has been introduced in the brewing chamber and the latter has been closed, the annular piston 16 is moved first, to squeeze the annular portion of the water container 7 between the annular shoulder 7S and the separating wall 3B. This causes the piercing plate 29 to move against the separating wall 3B and generate a plurality of apertures in the separating wall 3B by means of projections 29B, so that, when the central piston 15 is lowered (arrow f15) water, which has been previously heated by the heater 13, flows through the apertures 29A of the piercing plate 29 and through the apertures formed by the projections 29B in the separating wall 3B.

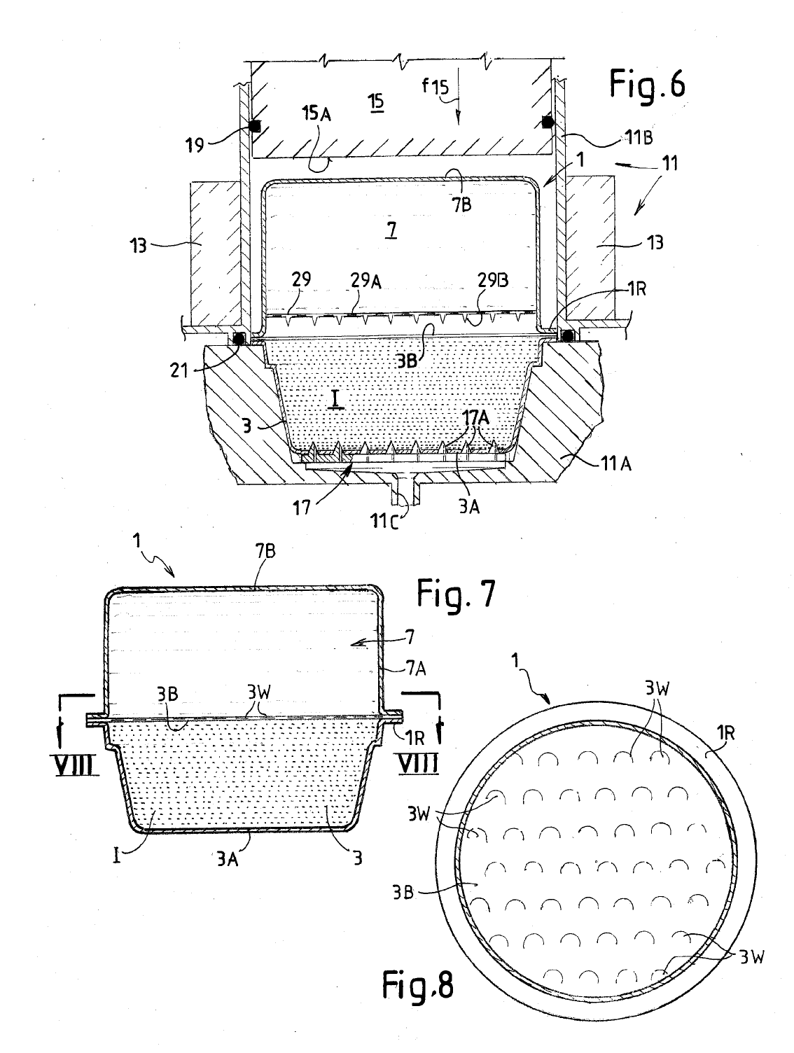

FIG. 6 illustrates a further embodiment of a capsule 1 and relevant capsule-receiving chamber 11 or brewing chamber. The same reference numbers designate the same or corresponding parts already described with respect to the previous embodiments and will not be described again. In the further embodiment of FIG. 6 a piercing plate 29 is provided, which can be attached to the inner surface of a substantially cylindrical side wall 7A of the liquid container 7. The perforating plate is provided with sharp tips or projections 29B arranged for aperturing the separating wall 3B and is further provided with small apertures 29A. The dimension of the apertures 29A is sufficiently small so that water will pass through the apertures 29A only when a sufficient pressure difference is established between one side and the other of the piercing plate 29.

When the piston 15 is lowered (arrow f15) after heating the water contained in the liquid container 7 through the magnetron 13, the pressure generated in the water due to the squeezing of the liquid container 7 causes firstly the piercing plate 29 to rupture the wall 3B in several points corresponding to the projections 29B, thus generating apertures through which the hot and pressurized water is then caused to flow to produce the beverage.

FIG. 7 illustrates a further embodiment of a capsule according to the invention. The same reference numbers are used to designate the same parts as in the previously described embodiments. In this embodiment the separating wall 3B, a top view of which is shown in the cross-section of FIG. 8, is provided with weakening lines 3W. These lines can be formed for example by locations where the separating wall 3B is thinner than in the remaining part of the separating wall.

When the capsule 1 is introduced in the capsule-receiving chamber 11 or brewing chamber and the water contained in the liquid container 7 has been heated by the heater 13, pressure is applied on top of the liquid container 7 by the piston 15 in quite the same manner as in the embodiments illustrated in FIGS. 4, 5 and 6. The increased water pressure in the inner volume of the liquid container 7 will cause the separating wall 3B to burst in correspondence of the weakening lines 3W, thus generating a plurality of apertures in the separating wall 3B, through which the hot and pressurized water contained in the liquid container 7 can flow to produce the beverage.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. The word “comprising” does not exclude the presence of elements or steps other than those listed in a claim. The word “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A capsule for preparing a beverage, comprising: an ingredient receptacle, which contains at least one ingredient (I) for the preparation of a beverage, a sealed liquid container containing an amount of liquid sufficient for the complete amount of said at least one ingredient (I) to preparing a beverage; wherein a liquid-tight separating wall is arranged between said liquid container and said ingredient receptacle, said separating wall being arranged to be ruptured causing said liquid to contact said at least one ingredient and produce said beverage, and a piercing arrangement for piercing said separating wall, wherein said piercing arrangement comprises a piercer arranged inside said liquid container and oriented towards the separating wall, said piercer being arranged for approaching and perforating said separating wall when said liquid container is collapsed or squeezed.

2. A capsule according to claim 1, wherein said liquid is water.

3. A capsule according to claim 1, wherein said liquid container and said ingredient receptacle are arranged and configured so that by rupturing the separating wall and collapsing or squeezing said liquid container, the liquid flows through the ingredient receptacle and the beverage produced is dispensed from the capsule.

4. (canceled)

5. (canceled)

6. A beverage producing device comprising: a capsule-receiving chamber configured for receiving a capsule, which capsule comprises a liquid container and an ingredient receptacle separated by a liquid-tight separating wall arranged therebetween; wherein said capsule-receiving chamber comprises means for squeezing or collapsing the liquid container of a capsule positioned in the capsule-receiving chamber, causing said liquid to contact at least one beverage ingredient contained in said ingredient receptacle and prepare a beverage therewith.

7. A beverage producing device according to claim 6, comprising a heat generator configured and arranged for heating said liquid contained in a capsule arranged in said capsule-receiving chamber.

8. A beverage producing device according to claim 7, wherein said heat generator comprises a micro-wave generator.

9. A beverage producing device according to claim 6, wherein said means for squeezing or collapsing the liquid container of a capsule positioned in the capsule-receiving chamber comprises two opposite end walls, movable one towards the other.

10. A beverage producing device according to claim 6, comprising a perforator for perforating an outer wall of a capsule positioned in said capsule-receiving chamber.

11. A system for producing a beverage from a capsule, said system comprising: capsule-receiving chamber; a capsule receivable in said capsule-receiving chamber, said capsule comprising a liquid container and an ingredient receptacle separated by a liquid-tight separating wall arranged therebetween; wherein said capsule-receiving chamber comprises means for squeezing or collapsing the liquid container of said capsule positioned in the capsule-receiving chamber, causing said liquid to contact at least one beverage ingredient contained in said ingredient receptacle and prepare a beverage therewith.

12. A system according to claim 11, further comprising a heat generator configured and arranged for heating the liquid contained in said liquid container of said capsule arranged in said capsule-receiving chamber.

13. A method for preparing a beverage using a single-serving capsule, said capsule comprising an ingredient receptacle, containing at least one ingredient for the preparation of the beverage, and a liquid container, containing an amount of liquid sufficient for the complete amount of said at least one ingredient to prepare a beverage, said method comprising the steps of:
introducing said capsule in a capsule-receiving chamber;
closing the capsule-receiving chamber;
causing the liquid contained in the liquid container to contact said at least one ingredient contained in said ingredient receptacle thus producing said beverage;
dispensing said beverage from the capsule-receiving chamber; and
squeezing or collapsing said liquid container, forcing the liquid to flow from said liquid container through said ingredient receptacle.

14. A method according to claim 13, comprising the step of heating said liquid prior to contacting said at least one ingredient.

15. (canceled)

16. A method according to claim 13, comprising the step of rupturing a separating wall, which separates the liquid container from the ingredient receptacle.
